(19) United States
(12) Patent Application Publication
(10) Pub. No.: US 2019/0147843 A1
(43) Pub. Date: May 16, 2019

(54) METHOD FOR THE MANUFACTURE OF VIBRATION DAMPING AND/OR SOUND ATTENUATING MATERIALS

(71) Applicant: Universal Fibers, Inc., Bristol, VA (US)

(72) Inventors: Stuart P. Fairgrieve, Kidlington (GB); Brendan F. McSheehy, JR., Abingdon, VA (US)

(21) Appl. No.: 16/185,408

(22) Filed: Nov. 9, 2018

Related U.S. Application Data
(60) Provisional application No. 62/585,183, filed on Nov. 13, 2017.

(51) Int. Cl. G10K 11/168; B32B 3/26; B32B 27/08; B32B 38/00

(52) U.S. Cl. CPC G10K 11/168; B32B 3/266; B32B 27/08; B32B 38/0004; B60R 13/0815; B32B 2471/02; B32B 2471/04; B32B 2605/003; B32B 2307/102

(57) ABSTRACT

The present invention is generally concerned with the use of a sheet lamination method to produce sheet-form materials with controlled cellular architecture, which may be used as vibration damping and/or sound attenuation materials. The materials described herein can exhibit superior vibration damping and/or sound attenuation properties compared to existing materials available in the industry. The method for the present invention involves the successive lamination of a series of films of polymer or composite material in which a plurality of apertures has been created. In such embodiments, the apertures can be of varying sizes in successive films and be positioned in such a manner that a plurality of three-dimensional cells are created in the final sheet-form material.

### RELATED APPLICATIONS

This application claims the priority benefit under 35 U.S.C. § 119(e) of U.S. Provisional Patent Application Ser. No. 62/585,183 entitled “METHOD FOR THE MANUFACTURE OF VIBRATION DAMPING AND/OR SOUND ATTENUATING MATERIALS,” filed Nov. 13, 2017, the entire disclosure of which is incorporated herein by reference.

### BACKGROUND

### 1. Field of the Invention

The present invention is generally concerned with vibration damping and/or sound attenuating cellular sheet-form materials constructed by additive manufacturing means.

### 2. Description of the Related Art

Cellular materials, such as polymeric or composite foams, have been known for some considerable time to provide useful vibration damping and sound attenuation effects in a multiplicity of applications. Such applications include, but are not limited to, domestic and commercial buildings; civil engineering; mass transport systems such as trains, aircraft, and ships; and the automotive industry.

It is generally known that the properties of the cells within such foams may have a profound effect on the efficiency of the vibration damping and sound attenuation properties of the foams. Such cell properties include, but are not limited to, size, shape, interconnectivity, openness to surrounding environment, distribution within the material, and size distribution. Such parameters are, however, difficult to control using standard cellular material production methods such as gas injection or incorporation of gas-producing additives within the polymer or composite material.

Additive manufacturing, also often referred to as three dimensional (“3D”) modeling or rapid prototyping, is a relatively new, but rapidly growing, approach to the manufacturing of 3D objects. Unlike traditional methods for making 3D objects, which involve machining a 3D part form a starting block of material by essentially removing, or subtracting, material therefrom, additive manufacturing, as the name implies, involves construction of an object by building up successive layers of material in an additive manner to achieve the final desired 3D object.

The most common methods of additive manufacturing are defined as follows (see ISO/ASTM 52900): (1) Material Extrusion—a nozzle extrudes a semi-liquid material to build up successive object layers; (2) Vat Polymerization—a laser or other light source solidifies successive object layers on the surface or base of a vat of liquid photopolymer; (3) Material Jetting—a print head selectively deposits droplets of a liquid build material that is cured or fused solid using UV light or heat, or which solidifies on contact; (4) Binder Jetting—a print head selectively sprays a binder onto successive layers of polymer powder; (5) Powder Bed Fusion—a laser or other heat source selectively fuses successive layers of powder; and (6) Directed Energy Deposition—a laser or other heat source fuses a powdered build material as it is being deposited.

All of the above additive manufacturing methods may be referred to as “1-dimensional” approaches. In other words, this means that each layer of the object being built is constructed by depositing lines of polymer adjacent to each other, or by raster scanning of an energy source onto a layer of material to again build up a single layer in a series of lines.

There is, however, another additive manufacturing approach which, by analogy with the above, may be referred to as a “2-dimensional” approach. This approach is sheet lamination, also referred to as laminated object manufacture (“LOM”), in which sheets of cut material, such as paper, plastic, or metal, are bonded in a stacked fashion to create a 3D object. This approach is described in U.S. Pat. No. 4,752,352, which is incorporated herein by reference in its entirety.

Although advances have been made in regard to materials for providing vibration damping and/or sound attenuation, there is still a need in the industry to produce improved vibration damping and/or sound attenuating materials, with well-characterized, controllable, cellular structures.

### SUMMARY

One or more embodiments of the present invention generally concern a flooring comprising a laminated sheet for vibration dampening and sound attenuation. The laminated sheet generally comprises: (a) a plurality of individual polymer films, wherein each of the individual polymer films comprises a plurality of apertures; and (b) a plurality of shaped cavities disposed within the laminated sheet, wherein the shaped cavities are cooperatively formed by the apertures of the individual polymer films.

One or more embodiments of the present invention generally concern a sheet-form material for vibration dampening and sound attenuation. The sheet-form material comprises: (a) a laminated sheet comprising a plurality of individual polymer films, wherein each of the individual polymer films comprise a plurality of apertures; and (b) a plurality of three-dimensional cells disposed within the laminated sheet, wherein the apertures are positioned in such a manner so as to cooperatively form the three-dimensional cells.

One or more embodiments of the present invention generally concern a method for manufacturing cellular sheet-form materials via an additive manufacturing process, such as a sheet lamination process. Generally, the method involves: a) forming a plurality of apertures in a first film at a first workstation; b) transferring the first film onto a previously-placed film already placed on a second workstation in a manner such that the apertures of the first film are substantially aligned with corresponding apertures of the previously-place film; c) bonding the first film to the previously-placed film at the second workstation; d) repeating steps a) to c) to build up a stack of films in a z-direction to thereby form a sheet-form material comprising a plurality of the films; and e) removing the sheet-form material from the second workstation, wherein the aligned apertures in the stack of films cooperatively form a plurality of three-dimensional cells in the sheet-form material.

One or more embodiments of the present invention generally concern a method for manufacturing cellular sheet-form materials via an additive manufacturing process, such as a sheet lamination process. Generally, the method involves: (a) placing an initial film onto a first workstation; (b) forming a plurality of apertures in the initial film by mechanical or energy means; (c) transferring the film onto a second workstation or onto a second film already placed on the second workstation; (d) bonding the initial film either temporarily to the second workstation or permanently to the second film on the workstation; (e) repeating steps (a) to (d) to build up a stack of films in a z-direction to thereby form a sheet-form material comprising a plurality of said films; (f) removing the sheet-form material from the second workstation; and (g) optionally cutting the sheet-form material to a desired x/y plane shape. In such embodiments, the apertures can be of a size and location such that the sheet-form material comprises a plurality of three-dimensional cells, wherein the cells are either totally enclosed and/or are open at the surface of the sheet-form material at one or both surfaces. Furthermore, the cells can be essentially spherical, ovoid, pear-shaped, or bottle-shaped.

### BRIEF DESCRIPTION OF THE FIGURES

Embodiments of the present invention are described herein with reference to the following drawing figures, wherein:

FIG. 1 depicts a flow chart of the inventive method according to various embodiments of the present invention;

FIG. 2 depicts a cross-sectional viewpoint of a floor product comprising the sheet-form material according to one embodiment of the present invention;

FIG. 3 depicts a cross-sectional viewpoint of the sheet-form material in FIG. 2 taken along the line 3-3;

FIG. 4 depicts a cross-sectional viewpoint of the sheet-form material comprising three-dimensional cells having a Florence flask cross-sectional shape;

FIG. 5 depicts a cross-sectional viewpoint of the sheet-form material comprising three-dimensional cells having an Erlenmeyer flask cross-sectional shape; and

FIG. 6 depicts a cross-sectional viewpoint of the sheet-form material having a diaphragm positioned within the three-dimensional cells according to one embodiment of the present invention.

### DETAILED DESCRIPTION

The present invention is generally concerned with the use of a sheet lamination method to produce sheet-form materials with controlled cellular architecture, which may be used as vibration dampening and/or sound attenuation materials. The materials described herein can exhibit superior vibration dampening and/or sound attenuation properties compared to existing materials available in the industry.

Areas of application for the inventive sheet-form material may include, but are not limited to, domestic, industrial, civil engineering, and automotive insulation interior paneling and parts (e.g., automotive floor carpeting/mats or backing for the carpeting/mats). For instance, the sheet-form materials may be directly used as sound-dampening flooring, such as tiles, or as sound-dampening mats between conventional flooring (e.g., carpet) and the baseboard in residential or commercial settings.

In various embodiments, the method for the present invention involves the successive lamination of a series of films of polymer or composite material in which a plurality of apertures has been created. In such embodiments, the apertures can be of varying sizes in successive films and be positioned in such a manner that a plurality of three-dimensional cells are created in the final sheet-form material. As used herein, the terms “cell,” “cells,” “cavity,” and “cavities” may be used interchangeably and refer to the three-dimensional voids formed within the sheet-form materials of the present invention.

The method of the present invention generally involves feeding a film of polymer or composite, either in the form of a continuous reel or in the form of separate sections, into a first workstation in which mechanical or energy means is used to remove material from a plurality of specified locations to thereby produce a plurality of apertures through a set area of the film. Subsequently, this set area of film is passed to a second workstation where it is either temporarily adhered or fused to a work platform or is permanently adhered or fused to a set area of a separate film already in position on the work platform. This process is then repeated, with the size, shape, and position of the plurality of apertures in successive films being varied in such a manner that cells are formed in the final sheet-form material once all the required film layers have been put in place. The resulting cells may be fully enclosed or opened to the surroundings at one or both surfaces of the sheet-form material.

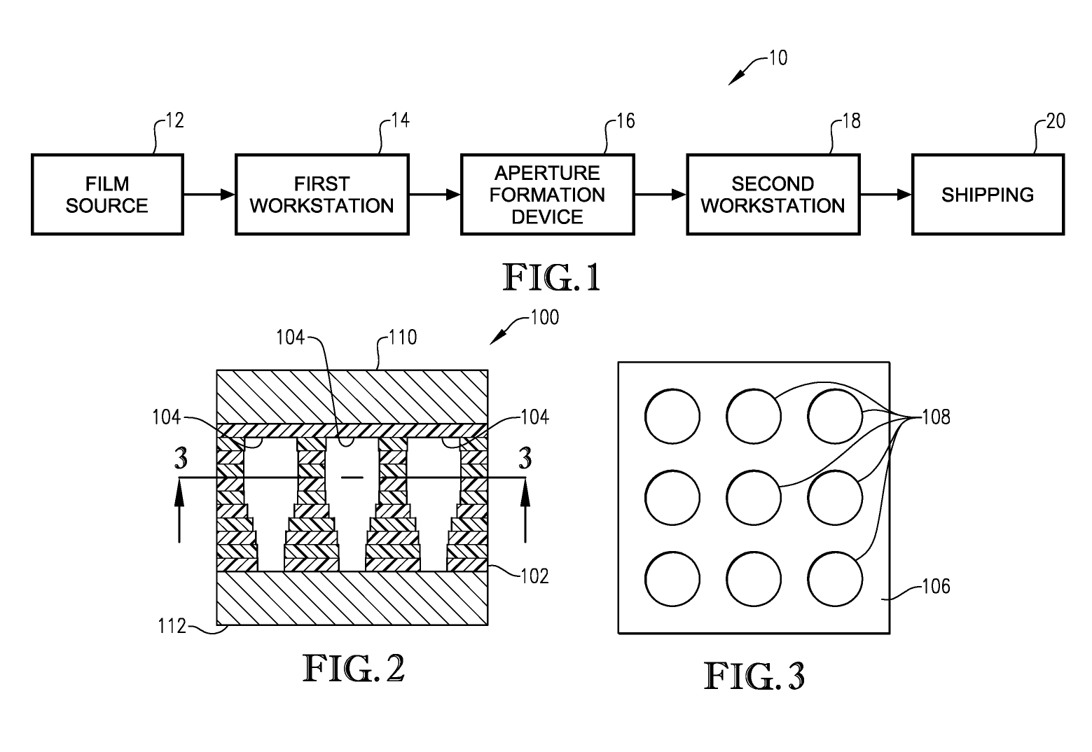

The method of the present invention is generally depicted in the flow chart of FIG. 1. As shown in FIG. 1, the method 10 begins by forming and/or feeding a polymer film from a film source 12, either in the form of a continuous reel or in the form of separate sections, into a first workstation 14. The film source 12 can include any known source of polymer films in the art. While at the first workstation 14, a plurality of apertures may be introduced into the film via the aperture forming device 16. The aperture forming device 16 can comprise any known device capable of introducing apertures into a polymer film, including a laser-based system and/or a system that uses physical tools to introduce the designed apertures into the films. Generally, the aperture forming device 16 may be integrated with a computer-aided design and drafting program (e.g., CAD software) so that the device 16 may incorporate the aperture design from the program directly into the polymer film. Subsequently, the aperture film is passed to a second workstation 18 where it is either temporarily adhered or fused to a work platform or is permanently adhered or fused to a separate film already in position on the work platform. The polymer or composite films may be bonded into the final sheet-form material by any suitable means, including, but not limited to, adhesive coating, laser or other energetic beam welding, infra-red heating, application of heated roller or platen, ultrasonic welding, surface treatment with corona discharge or plasma, or any combination of these methods. This process is then repeated, with the size, shape, and position of the plurality of apertures in successive films being varied in such a manner that cells are formed in the final sheet-form material once all the required film layers have been put in place. The resulting cells may be fully enclosed or opened to the surroundings at one or both surfaces of the sheet-form material. After laminating multiple film layers together, the resulting laminated sheets may be shipped 20 to customers.

In certain embodiments, the inventive method is carried out under a programmed computer control using appropriate CAD software.

Generally, the inventive sheet-form material produced from the above-referenced method comprises: (a) a laminated sheet comprising a plurality of individual polymer films, wherein each of the individual polymer films comprise a plurality of apertures and (b) a plurality of three-dimensional cells disposed within the laminated sheet, wherein the apertures are positioned in such a manner so as to cooperatively form the three-dimensional cells or cavities. In certain embodiments, the aligned apertures of at least some of the adjacent films of the stack of films are differently sized so that the sidewalls of the cells are not entirely perpendicular to the surfaces of the sheet-form material.

The three-dimensional cells formed within the laminated sheet of the sheet-form material may function as acoustic cavity resonators that may absorb sound in a specific frequency range. The frequency range absorbed by the cells may be affected by the size of the cavity, the length of the opening of the cavity, and the volume of the cavity. In certain embodiments, the three-dimensional cells within the laminated sheets of the sheet-form materials may function as Helmholtz resonators.

Without wishing to be bound by theory, it is believed that the three-dimensional cells within the laminated sheets of the sheet-form materials may function as porous absorbers that utilize thermal interactions to dissipate acoustic energy and thereby convert such energy into heat.

In various embodiments, the sheet-form materials, particularly the three-dimensional cells within the laminated sheets of the sheet-form materials, may exhibit a transmission loss of at least 10, 15, 20, 25, 30, 35, 40, or 45 decibels at a frequency of 200, 250, 300, 325, 350, 375, 400, 425, 450, 475, or 500 hertz.

In various embodiments, the sheet-form materials, particularly the three-dimensional cells within the laminated sheets of the sheet-form materials, may exhibit a sound absorption coefficient of at least 0.1, 0.2, 0.3, 0.4, 0.5, 0.6, 0.7, 0.8, or 0.9 at a frequency of 100, 120, 140, 160, 180, 200, 220, 240, 260, 300, 400, 500, 600, 700, 800, 900, 1,000, 1,100, 1,200, 1,300, 1,400, 1,500, 1,600, 1,700, 1,800, 1,900, or 2,000 hertz.

The resulting apertures in the polymer films that are used to form the three-dimensional cells within the sheet-form materials may be of any shape, including, but not limited to, round, oval, rectangular, triangular, square, or hexagonal. In various embodiments, the apertures are round. Furthermore, in various embodiments, the apertures in the polymer films may comprise specifically-shaped sidewalls depending on the intended shape of the resulting three-dimensional cells within the laminated sheets of the sheet-form materials. For example, the apertures may have straight sidewalls (i.e., sidewalls that are perpendicular to the baseline of the film) or conical/curved sidewalls. In certain embodiments, at least some of the sidewalls are differently sized so that the resulting three-dimensional cells are not entirely perpendicular to the surfaces of the sheet-form material

In one or more embodiments, the three-dimensional cells within the sheet-form materials can comprise various types of cross-sectional shapes depending on the desired frequency to be dampened. In various embodiments, the three-dimensional cells formed within the laminated sheets of the sheet-form material may have a cross-sectional shape that is spherical, ovoid, pear-shaped, or bottle-shaped. In certain embodiments, the three-dimensional cells formed within the laminated sheets of the sheet-form material may have a cross-sectional shape that is in the form of a Florence flask, an Erlenmeyer flask, or a bottle.

Furthermore, in various embodiments, the cells present in the final sheet-form material of the invention may all be the same size or may vary in size over the area of the final sheet-form material. For instance, in various embodiments, the plurality of shaped cells may comprise a first set of cavities having a first defined volume and a second set of cavities having a second defined volume that is different from the first defined volume. In such embodiments, the second set of cavities can have a volume that is at least 10, 20, 30, 40, or 50 percent greater than the volume of the first set of cavities.

In various embodiments, the cells may be fully enclosed, open to one or both surfaces of the sheet-form material, or a combination thereof. In certain embodiments, the cells may be fully enclosed within the laminated sheets of the sheet-form material.

In one or more embodiments, the three-dimensional cells may comprise one or more openings on at least one surface of the sheet-form material. For instance, each of the three-dimensional cells within the laminated sheets of the sheet-form materials may comprise at least 1, 2, 3, or 4 openings on one or both surfaces of the laminated sheets of the sheet-form material. In various embodiments, the openings of the three-dimensional cells can have a defined shape, such as a cylindrical shape, an oval shape, a square shape, and/or a hexagonal shape.

In certain embodiments, the sheet-form material may comprise a first set of three-dimensional cells having a first set of openings on a surface of the sheet-form material and a second set of three-dimensional cells having a second set of openings on a surface of the sheet-form material, wherein the openings of the first set of openings and the second set of openings have different widths or diameters. In such embodiments, these different openings can be used to capture and dampen different sound frequencies within the two sets of three-dimensional cells.

FIG. 2 depicts an exemplary flooring application 100 for automotive mats that comprises the sheet-form material 102 of the present invention. As shown in FIG. 2, the flooring product 100 comprises the sheet-form material 102 (in the form of a laminated sheet), which contains multiple three-dimensional cells 104 disposed therein that are formed by the apertures in each of the films in the laminated film stack. FIG. 2 also depicts the apertures in each of the films having straight sidewalls (i.e., sidewalls that are perpendicular to the baseline of the film).

FIG. 3 provides a cross-sectional view of the sheet-form material 102 taken along line 3-3. As shown in FIG. 3, the sheet-form material comprises individual polymer films 106 that comprise a plurality of apertures 108, which form the three-dimensional cells of the sheet-form material.

Turning back to FIG. 2, the flooring product 100 may also comprise a flooring top layer 110 and an optional backing layer 112. The flooring top layer 110 can comprise any floor covering known in the art, such as a carpet, vinyl, or tile layer. The optional backing layer 112, when present, may comprise any layer known in the art that provides structural support to the flooring product. For example, the optional backing layer 112 may comprise an elastomeric layer, a nonwoven layer, a woven layer, or any other structural layer commonly used in the flooring arts.

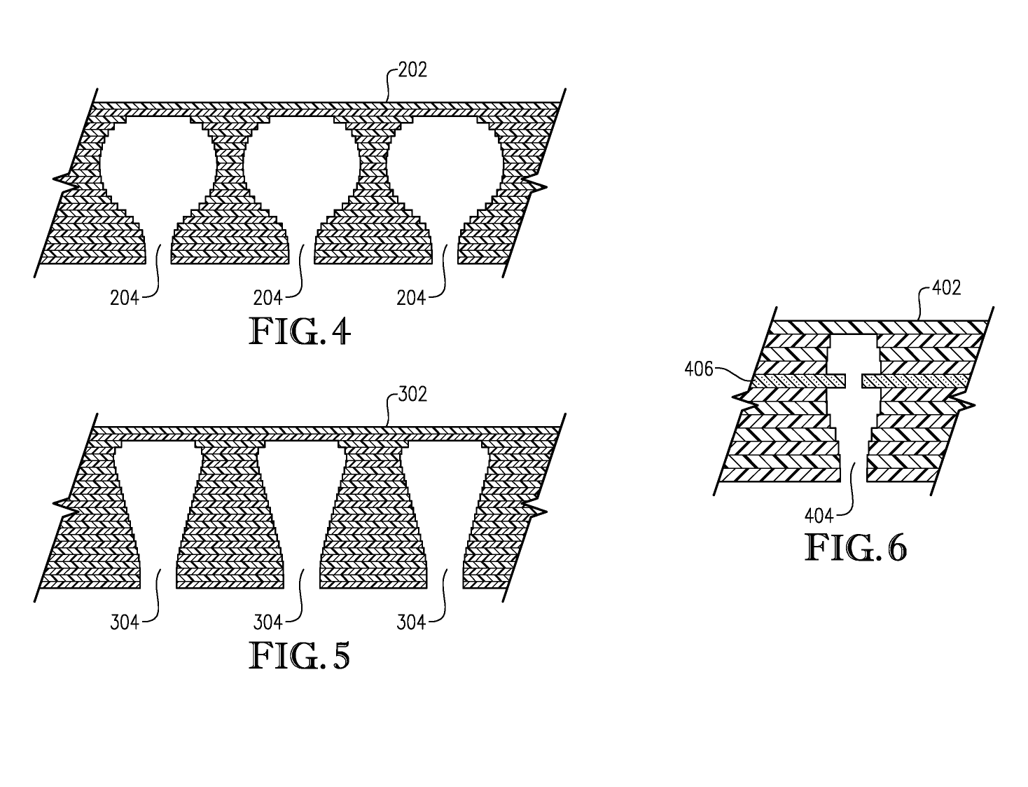

FIGS. 4 and 5 depicts embodiments of the sheet-form materials with three-dimensional cells having alternative cross-sectional shapes. FIG. 4 depicts a sheet-form material 202 comprising a plurality of three-dimensional cells 204 having a Florence flask cross-sectional shape. As shown in FIG. 4, each of the three-dimensional cells 204 have an opening on one surface of the sheet-form material 202. Furthermore, as shown in FIG. 4, the apertures forming the three-dimensional cells 204 have straight sidewalls (i.e., sidewalls that are perpendicular to the baseline of the film).

FIG. 5 depicts a sheet-form material 302 comprising a plurality of three-dimensional cells 304 having an Erlenmeyer flask cross-sectional shape. As shown in FIG. 5, each of the three-dimensional cells 304 have an opening on one surface of the sheet-form material 202. Furthermore, as shown in FIG. 5, the apertures forming the three-dimensional cells 304 have straight sidewalls (i.e., sidewalls that are perpendicular to the baseline of the film).

In one or more exemplary embodiments, the sheet-form material may comprise a plurality of three-dimensional cells having a spherical cross-sectional shape, which are totally enclosed within the sheet-form material in a designated pattern. In such embodiments, the spherical cells may all be of the same size and volume or, alternatively, may comprise cells having different sizes and volumes.

In one or more exemplary embodiments, the sheet-form material may comprise a plurality of three-dimensional cells having a cross-sectional Florence flask shape, which comprise a cylindrical-shaped opening on a surface of the sheet-form material. The cells may be produced from apertures having curved sidewalls. In such embodiments, the cells may all be of the same size and volume or, alternatively, may comprise cells having different sizes and volumes. Furthermore, the cylindrical openings may be of the same width and diameter or, alternatively, may have different widths and diameters. Generally, all of the openings are found on the same surface of the sheet-form material.

In one or more exemplary embodiments, the sheet-form material may comprise a plurality of three-dimensional cells having a cross-sectional Erlenmeyer flask shape, which comprise a cylindrical-shaped opening on a surface of the sheet-form material. The cells may be produced from apertures having curved sidewalls. In such embodiments, the cells may all be of the same size and volume or, alternatively, may comprise cells having different sizes and volumes. Furthermore, the cylindrical openings may be of the same width and diameter or, alternatively, may have different widths and diameters. Generally, all of the openings are found on the same surface of the sheet-form material.

In one or more exemplary embodiments, the sheet-form material may comprise a plurality of three-dimensional cells having a cross-sectional bottle shape, which comprise a cylindrical-shaped opening on a surface of the sheet-form material. The cells may be produced from apertures having curved sidewalls. In such embodiments, the cells may all be of the same size and volume or, alternatively, may comprise cells having different sizes and volumes. Furthermore, the cylindrical openings may be of the same width and diameter or, alternatively, may have different widths and diameters. Generally, all of the openings are found on the same surface of the sheet-form material.

In one or more exemplary embodiments, the sheet-form material may comprise a plurality of three-dimensional cells formed from apertures having straight sidewalls. In such embodiments, the ends of the essentially straight-sided cells, positioned proximate to the two surfaces of the sheet-form material, may be entirely enclosed or covered by one or more of the films used in the manufacture of the sheet-form material. The cross-sectional shape of each of the cells may be the same or different, and may include, but is not limited to, round, oval, square, rectangular, triangular, and hexagonal cross-sectional shapes. The plurality of essentially straight-sided cells may all be of the same size or may consist of cells of several different sizes, arrayed in a chosen pattern.

The polymer films used to produce the sheet-form materials can be formed from several different types of synthetic thermoplastic polymers. For instance, the polymer films used to produce the sheet-form materials may comprise, consist essentially of, or consist of any suitable thermoplastic polymer, including, but not limited to, polyolefin, styrenic, acrylic, vinyl chloride (co)polymer, vinyl (co)polymers, polyamide, polyester, polyurethane, thermoplastic elastomer, or combinations thereof. In certain embodiments, the films may comprise, consist essentially of, or consist of composite materials comprised of any of the foregoing polymers.

In various embodiments, the polymer films used to produce the sheet-form materials can be formed from virgin and/or recycled polymer feedstocks.

In various embodiments, the polymer films used to produce the sheet-form materials can be in the form of foams. Generally, the desired density of these foams may depend on the structural and acoustical objectives of the sheet-form materials. In certain embodiments, the sheet-form materials may comprise a plurality of film layers made up of foam films having different or identical structural and acoustical properties.

Additionally, in various embodiments, the polymer films used to produce the sheet-form materials may comprise one or more materials selected from inorganic powders, carbon allotropes, carbon fibers, glass fibers, ceramic fibers, and metal fibers.

In various embodiments, the polymer films may also comprise active adjuvants, including, but not limited to, heat stabilizers, UV stabilizers, antimicrobials, antistatics, lubricants, colorants, nucleating agents, fire retardants, smoke suppressants, or a combination thereof.

In various embodiments, the final sheet-form materials of the present invention may be constructed using films made from the same polymer material or from films made from dissimilar materials in any specified order. For example, the laminated films of the sheet-form materials may be produced from polymer films made entirely from polyester. Alternatively, for example, the laminated films of the sheet-form materials may be produced from polyester films and polyamide films.

Moreover, in various embodiments, the films used in the present invention may be of any suitable thickness, preferably between about 0.1 mm and about 1.00 mm, and the thickness of each film within the sheet-form material may be the same or different. Any suitable number of films may be used in the construction of the inventive sheet-form material, preferably between about 10 and about 50. For instance, the final sheet-form material can comprise at least 1, 2, 3, 4, 5, 6, 7, 8, 9, or 10 films and/or not more than 100, 95, 90, 85, 80, 75, 70, 65, 60, 55, or 50 films.

Generally, the x/y dimensions of the sheet-form materials of the present invention will depend upon the dimensions of the workstations used in the method of the invention. In certain embodiments, the x/y dimensions of the sheet-form materials can be up to about 1 m². The sheet-form material of the invention may be constructed to its final x/y dimensions and shape during the processes inherent in the method of the invention or may be produced as a square or rectangular “blank” and shaped to its final dimensions in a separate process.

In various embodiments, the sheet-form materials may comprise an optional interlayer disposed within the stack of laminated polymer sheets, which can function as a diaphragm within the cells of the sheet-form materials. More particularly, these interlayers may at least partially intersect the cells formed by the laminated polymer sheets. In such embodiments, the interlayer can partially intersect the cells within the sheet-form materials so that an opening still persists in the cell. Consequently, in various embodiments, this interlayer can function as a diaphragm within the constructed cells of the sheet-form materials and may help attenuate the sound dampening of certain frequencies within the cells.

This optional interlayer can be introduced at any stage during the aforementioned process, as long as one polymer film is already present at the second workstation. Like the polymer films, specifically designed apertures may be cut into this interlayer using the same aperture formation device used on the polymer films. The interlayers may be processed in the same manner as discussed above for the polymer films during the method of the present invention.

In various embodiments, the interlayer can be formed of a non-woven material. Furthermore, in various embodiments, the interlayer can be produced from a synthetic or natural material, such as polyolefin, styrenic, acrylic, vinyl chloride (co)polymer, vinyl (co)polymers, polyamide, polyester, polyurethane, thermoplastic elastomer, cellulose, glass, or combinations thereof.

FIG. 6 depicts a sheet-form material 402 comprising a three-dimensional cell 404 having a cross-sectional bottle shape. The sheet-form material 402 also comprises an interlayer 406 that partially intersects the three-dimensional cell 404. However, the interlayer 406 leaves an opening within the three-dimensional cell 404. Thus, in such embodiments, the interlayer 406 may form a diaphragm within the cell 404.

The sheet-form materials of the present invention may be used in any application that requires vibration dampening and/or sound attenuation. Areas of application for the inventive sheet-form material may include, but are not limited to, domestic, industrial, civil engineering, building, mass transport, and automotive insulation interior paneling and parts (e.g., automotive floor carpeting/mats or backing for the carpeting/mats). For instance, the sheet-form materials may be directly used as sound-dampening flooring, such as tiles, or as sound-dampening mats between conventional flooring (e.g., carpet) and the baseboard in residential or commercial settings.

In various embodiments, the sheet-form materials can be used as a backing component in automobile carpets or mats.

In various embodiments, the sheet-form materials can be in the form of flooring tiles. In such embodiments, the tiles formed from the sheet-form materials can provide superior sound attenuation and vibration dampening compared to conventional vinyl tiles used in the industry.

### Definitions

It should be understood that the following is not intended to be an exclusive list of defined terms. Other definitions may be provided in the foregoing description, such as, for example, when accompanying the use of a defined term in context.

As used herein, the terms “sheet-form materials” and “laminated films” may be used interchangeably and may refer to the inventive product described herein.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

### Numerical Ranges

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

### Claims not Limited to Disclosed Embodiments

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

What is claimed is:

1. A flooring comprising a laminated sheet for vibration dampening and sound attenuation, said laminated sheet comprising:
(a) a plurality of individual polymer films, wherein each of said individual polymer films comprises a plurality of apertures; and
(b) a plurality of shaped cavities disposed within said laminated sheet, wherein said shaped cavities are cooperatively formed by said apertures of said individual polymer films.

2. The flooring according to claim 1, wherein said laminated sheet exhibits a transmission loss of at least 10 decibels at a frequency of 200 hertz.

3. The flooring according to claim 1, wherein said shaped cavities comprise a cross-sectional shape in the form of a Florence flask, an Erlenmeyer flask, or a bottle.

4. The flooring according to claim 1, wherein said apertures comprise sidewalls, wherein at least some of said sidewalls are differently sized so that said shaped cavities are not entirely perpendicular to the surfaces of the laminated sheet.

5. The flooring according to claim 1, wherein said individual polymer films are formed from at least one thermoplastic polymer selected from the group consisting of a polyolefin polymer, a styrenic polymer, an acrylic polymer, a vinyl chloride (co)polymer, a polyamide polymer, a polyester polymer, a polyurethane polymer, and a thermoplastic elastomer.

6. The flooring according to claim 1, wherein said shaped cavities comprise at least one opening on a surface of the laminated sheet.

7. The flooring according to claim 1, wherein said flooring comprises a flooring top layer positioned on said laminated sheet.

8. The flooring according to claim 7, wherein said flooring comprises an automobile carpet or mat.

9. A sheet-form material for vibration dampening and sound attenuation, said sheet-form material comprising:
(a) a laminated sheet comprising a plurality of individual polymer films, wherein each of said individual polymer films comprise a plurality of apertures; and
(b) a plurality of three-dimensional cells disposed within said laminated sheet, wherein said apertures are positioned in such a manner so as to cooperatively form said three-dimensional cells.

10. The sheet-form material according to claim 9, wherein said sheet-form material exhibits a transmission loss of at least 10 decibels at a frequency of 200 hertz.

11. The sheet-form material according to claim 9, wherein said three-dimensional cells comprise a cross-sectional shape in the form of a Florence flask, an Erlenmeyer flask, or a bottle.

12. The sheet-form material according to claim 9, wherein said apertures comprise sidewalls, wherein at least some of said sidewalls are differently sized so that said three-dimensional cells are not entirely perpendicular to the surfaces of the sheet-form material.

13. The sheet-form material according to claim 9, wherein said individual polymer films are formed from at least one thermoplastic polymer selected from the group consisting of a polyolefin polymer, a styrenic polymer, an acrylic polymer, a vinyl chloride (co)polymer, a polyamide polymer, a polyester polymer, a polyurethane polymer, and a thermoplastic elastomer.

14. The sheet-form material according to claim 9, wherein said three-dimensional cells comprise at least one opening on a surface of the sheet-form material.

15. A method for the manufacture of cellular sheet-form materials via a sheet lamination process, said method comprising:
a) forming a plurality of apertures in a first film at a first workstation;
b) transferring said first film onto a previously-placed film already placed on a second workstation in a manner such that said apertures of said first film are substantially aligned with corresponding apertures of said previously-place film;
c) bonding said first film to said previously-placed film at said second workstation;
d) repeating steps a) to c) to build up a stack of films in a z-direction to thereby form a sheet-form material comprising a plurality of said films; and
e) removing said sheet-form material from said second workstation,
wherein the aligned apertures in said stack of films cooperatively form a plurality of three-dimensional cells in said sheet-form material.

16. The method according to claim 15, further comprising inserting an interlayer between said first film and said previously-placed film.

17. The method according to claim 15, further comprising cutting said sheet-form to a desired x/y plane shape.

18. The method according to claim 15, wherein said sheet-form material exhibits a transmission loss of at least 10 decibels at a frequency of 200 hertz.

19. The method according to claim 15, wherein said three-dimensional cells comprise a cross-sectional shape in the form of a Florence flask, an Erlenmeyer flask, or a bottle.

20. The method according to claim 15, wherein said first film and said previously-placed film are formed from at least one thermoplastic polymer selected from the group consisting of a polyolefin polymer, a styrenic polymer, an acrylic polymer, a vinyl chloride (co)polymer, a polyamide polymer, a polyester polymer, a polyurethane polymer, and a thermoplastic elastomer.
